(19) United States
(12) Patent Application Publication
(10) Pub. No.: US 2007/0195321 A1
(43) Pub. Date: Aug. 23, 2007

(54) Chip reader for biochips and associated methods

(76) Inventors: Francoise Soussaline, Paris (FR); Elena Khomyakova, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/540,516

(22) PCT Filed: Dec. 23, 2003
(86) PCT No.: PCT/FR03/03886

§ 371 Date: May 15, 2006

(30) Foreign Application Priority Data
Dec. 23, 2002 (FR) 02/16500

(51) Int. Cl. G01J 3/30; G01N 21/64

(52) U.S. Cl. 356/318; 250/458.1

(57) ABSTRACT

The invention relates to a device which is used to read and analyse chips. The inventive device comprises a table (11) for receiving a chip (12) that is intended to characterise at least one sample, means of exciting the molecules or cells of the chip after reaction with other molecules and means (14) of reading and analysing the molecules subjected to excitation. The invention is characterised in that the device also comprises: a unit (15) for controlling the temperature of the aforementioned table, said control unit being connected to a module (111) consisting of a plurality of Peltier-type heating/cooling elements which are disposed opposite different slots on the surface of the table; and at least one table temperature sensor (112) which is also connected to said control unit. The invention also relates to the associated methods.

### GENERAL CONTEXT

The present invention relates, in general, to the reading and interpretation of chips, and more particularly to the detection of hybrids labeled with signal-generating molecules, such as fluorophores, and formed between the molecules constituting these chips and molecules or cells originating from biological or chemical samples.

According to a first aspect, the invention thus relates to a device for reading and analyzing chips (or chip reader), comprising:
a table for receiving a chip intended to characterize at least one sample,
means of exciting the molecules or the cells of the chip, after reaction with other molecules,
means of reading and analyzing the molecules subjected to excitation.

More particularly, the invention also provides a means of controlling the temperature of the chips, thus making it possible to develop applications involving changes in temperature of the chip.

In a particular application, the chip is a DNA or oligonucleotide chip, and the control of the temperature makes it possible to precisely define the hybridization temperature of oligonucleotide probes on said chip.

The invention also relates to methods of using such a reader, in particular for detecting genetic mutations.

### DEFINITIONS

Before presenting the aims and characteristics of the invention, certain terms, which will be used in this text, will initially be defined.

The terms “array, micro-array, chip”, which will be used equally in the present invention, are intended to define an array of cells or of biological or chemical molecules arranged on a solid support in specific spots (forming, for example, a matrix).

The molecules or cells are typically attached to respective spots on a solid support coated with a polymer, and arranged such that each of these spots is of the type associated with a molecule/cell that exhibits a specificity with respect to the molecules/cells of the other spots.

When the array comprises biological molecules such as nucleic acids or peptides, reference is made to a biochip.

More precisely, when the array consists of deoxyribonucleotides, reference is made to a DNA chip or an oligonucleotide chip.

The solid support is chosen from solid supports made of glass, plastic, Nylon®, Kevlar®, silicone, silicon, or else polysaccharides or poly(heterosaccharides), such as cellulose.

It is preferably glass. This support may be in any form (flat slide, microbeads, etc.), but, according to a preferred embodiment, the support is a plane, and it involves a flat glass slide.

When the chip is brought into contact with a sample under appropriate conditions, certain components of the sample can react selectively with (and in particular bind to) one or more molecules/cells of the chip.

In addition, these components contain labels (typically fluorescent dyes or molecules—that are generally referred to as “fluorophores”) that make it possible to detect the presence of the components after the sample has been brought into contact with the chip. This detection requires, in the case of fluorophores, excitation of the chip with light of controlled wavelengths.

The term “molecule” here covers chemical molecules and biological molecules.

For biological applications, the “biological molecules” are preferably nucleic acids, more preferably single-stranded oligonucleotides.

For chemical applications, they may be chemical ligands for biological molecules.

The terms “nucleic acid, nucleic acid probe, nucleic acid sequence, polynucleotide, oligonucleotide, polynucleotide sequence, nucleotide sequence, oligonucleotide sequences”, which will be used equally in the present description, are intended to denote a precise chain of modified or unmodified nucleotides, making it possible to define a fragment or a region of a nucleic acid, containing or not containing unnatural nucleotides, and which may correspond equally to a double-stranded DNA, a single-stranded DNA, a PNA (for “peptide nucleic acid”) or LNA (for “locked nucleic acid”) and transcription products of said DNAs, such as RNA.

The term “probe, oligonucleotide probe or oligonucleotide” will here be intended to denote the functionalized or nonfunctionalized oligonucleotide that will be deposited (or “spotted”) onto and attached by covalent bonding directly or indirectly to the solid support via a spacer compound at the level of a spot.

The oligonucleotide thus spotted is capable of binding to a target nucleic acid of complementary sequences (i.e. a complementary oligonucleotide or polynucleotide) present in the sample, by means of one or more types of chemical bonds, usually through complementary base pairing, forming hydrogen bonds.

Preferably, said probes are single-stranded DNAs or RNAs, preferably DNAs, the size of which is between 10 and 7000 bases (b), preferably between 10 and 1000 b, between 10 and 500 b, between 10 and 250 b, between 10 and 100 b, between 10 and 50 b or between 10 and 35 b.

The oligonucleotide probes spotted can be chemically synthesized, purified from the biological sample or, more generally, produced by recombinant DNA technologies from natural and/or purified polynucleotides.

Of the examples, the probes may be produced by polymerase chain reaction (PCR) or by RT-PCR (reverse transcription followed by polymerase chain reaction).

The term “spots” corresponds to the sites on the chip where the molecules are attached.

Several copies of the same molecule are preferably present at a spot.

The spots are defined by their x- and y-coordinates relative to a reference point on the chip.

A spot can, for example, correspond to a circle having a diameter that depends on the volume of a drop of solution spotted in a defined zone of a plane, or to a well, or else to a parallelepipedal-shaped pad of gel (called gel pad).

The term “sample” corresponds to a solution of biological, biochemical or chemical molecules or to a cell group, for which it is desired to characterize certain properties.

In a preferred application of the invention, the sample is a solution containing at least one polynucleotide obtained from a biological source.

The sample may originate from a live or dead source coming from various tissues or cells.

Examples of biological samples comprise biological fluids, such as blood (in particular leukocytes), urine, saliva, sperm, or vaginal secretions, the skin, and also cells such as hair root follicle cells, cells from normal or pathological internal tissues, in particular originating from tumors, cells from chorion villus tissues, amniotic cells, placental cells, fetal cells, and umbilical cord cells.

The term “label” or “signal-generating label” is intended to denote a label that can be directly or indirectly associated with a biological, biochemical or chemical molecule of the sample, for the purpose of subsequently detecting it using reading means such as those of the readers according to the invention.

The signal-generating label is preferably selected from enzymes, dyes, haptens, ligands such as biotin, avidin, streptavidin or digoxygenin, or luminescent agents.

Preferably, the signal-generating label according to the invention is a luminescent agent, which, depending on the source of excitation energy, can be classified as radioluminescent, chemiluminescent, bioluminescent and photoluminescent (including fluorescent and phosphorescent).

Preferably, the signal-generating label according to the invention is a fluorescent agent.

The term “fluorescent” refers, in general, to the property, of a substance such as a fluorophore, of producing light when it is excited by a light source in a given wavelength, called excitation wavelength, and of emitting a light in a higher wavelength, called emission wavelength, which may be detected using a photon sensor, providing signals which, when combined, will make it possible to constitute an image of the hybridization signals of the chip.

Among the fluorophores used in the invention, mention may be made, non-exhaustively, of:
fluorescein isothiocyanate (FITC) [maximum absorption wavelength: 494 nm/maximum emission wavelength: 517 nm];
Texas Red (TR) [maximum absorption wavelength: 593 nm/maximum emission wavelength: 613 nm];
cyanine 3 (Cy3) [maximum absorption wavelength: 554 nm/maximum emission wavelength: 568 nm];
cyanine 5 (Cy5) [maximum absorption wavelength: 652 nm/maximum emission wavelength: 670 nm];
cyanine 5.5 (Cy5.5) [maximum absorption wavelength: 675 nm/maximum emission wavelength: 694 nm];
cyanine 7 (Cy7) [maximum absorption wavelength: 743 nm/maximum emission wavelength: 767 nm];
Bopidy 630/650 [maximum absorption wavelength: 632 nm/maximum emission wavelength: 658 nm];
Alexa 488 (495/519);
Alexa 350 (347/422);
Rhodamine Red dye (570/590).

The term “reaction” denotes a chemical or biological reaction (hybridization, for example) that takes place between a molecule associated with a spot on the chip and a molecule of the sample.

The term “hybridization” denotes a reaction that refers to the binding between a deposited (or spotted) oligonucleotide and a target sequence originating from the biological sample, by complementary base pairing.

The hybrid or duplex resulting from the hybridization is called a hybridization complex or hybridization duplex.

A hybridization complex can be either a complementary complex or a complex with mismatching.

Thus, a complementary complex is a hybridization complex in which there is no mismatching between the oligonucleotide spotted and the target sequence(s) of the sample.

A complex with mismatching is a hybridization complex in which there is at least one mismatch between the oligonucleotide spotted and the target sequence(s) of the sample.

The term “specific hybridization” refers to the binding, to the formation of a duplex, or to the hybridization of a nucleic acid molecule, only on a specific nucleotide sequence under stringent conditions, and when the sequence is present in a complex DNA or RNA environment.

A “complementary oligonucleotide” is a probe whose sequence is completely complementary to a specific target sequence (in this text, the term “match” will be used to denote this type of perfect pairing).

A probe exhibiting a “mismatch” refers to a probe or probes whose sequence is not completely complementary to a specific target sequence.

Although the mismatch may be located anywhere in the probe exhibiting mismatches, terminal mismatches are less desirable since they will have less effect on the hybridization on the target sequence.

Thus, the probes frequently have a mismatch located at the center or to the side of the center of the probe, such that the mismatch has a greater change of destabilizing the duplex with the target sequence under hybridization conditions.

The term “duplex” or “hybrid” corresponds to a double-stranded DNA fragment. It will be seen that such duplexes are obtained by hybridization of oligonucleotides (molecules arranged in spots on the chip) with the single-stranded fragments of a sample that it is desired to characterize.

The term “reading” generally denotes the process consisting in collecting, by means of one or more suitable sensors, the response of the molecules after reaction, with a view to detecting a label.

This reading can in particular be optical reading, but, as an alternative, can also be reading by collecting a signal such as a radioactive radiation.

It will be noted that, in this text, the definition of the chip “reader” goes beyond this simple reading process, since it also comprises the analysis of the signals “read”.

### PROBLEMS TO BE SOLVED AND SUMMARY OF THE INVENTION

“Light Source” Aspect

Chip readers of the type mentioned above are already known.

Such readers make it possible to collect, after reaction of the molecules of a chip with the molecules of a sample, the response of said molecules to a given excitation.

The collection of this response makes it possible to identify labels that react specifically to said excitation, which may in particular be an illumination (excitation by light) centered on a given wavelength.

The chip, preferably in the form of a plane, is placed on a table, which can be moved along three longitudinal, transverse and vertical axes x, y and z, so as to successively receive on the various spots (or spot subsets) on the chip the excitation radiation, and present to the observation means these various spots.

The chip can be placed directly on the table or else in a treatment chamber (for example, hybridization chamber) which is itself attached to the table.

Alternatively, the table can be fixed (in the case of excitation and observation means that move so as to scan the wells of the chip).

These readers comprise excitation means that are generally in the form of a light source (of the order of a few hundred square microns to a few square millimeters) that makes it possible to illuminate the molecules or the cells of the chip with a spectrum of controlled wavelength, so as to cause the excitation of a signal-generating label, preferably a fluorescent label, that is sought in combination with the molecule.

These means of illumination are generally in the form of a lamp (typically a xenon or mercury lamp), or of one or more laser diode(s).

Xenon lamps provide a continuous and even spectrum, covering the excitation wavelengths of most of the labels normally used.

However, a limitation of these lamps is that the level of energy associated with the excitation lines for the various labels can be too low to produce sufficient excitation of the lines desired.

As regards mercury lamps, they provide a spectrum exhibiting lines (energy maxima) for certain wavelengths.

Such lamps thus make it possible to sufficiently excite the fluorescent labels that are excitable at the wavelengths corresponding to these lines.

However, the excitation lines of mercury lamps do not comprise in particular the wavelengths for exciting the fluorophore (which may be of the Cy5 or Cy7 type or another fluorophore that can not be effectively excited by a broad-spectrum lamp) commonly used in the applications of these readers. This constitutes a considerable limitation of mercury lamps.

As an alternative to lamps, it is known practice to realize the means of illumination of the reader in the form of one or more laser(s) of given wavelength(s).

“Red” lasers, which are very common and not very expensive, thus constitute a practical and accessible solution for exciting labels such as cyanine 5 or cyanine 7. However, when it is desired to excite labels that are reactive at wavelengths located in the blue or close to blue ranges of ultraviolet light (for example, for exciting a label of the FITC type), it is necessary to use a laser of less common type, which results in a considerable drawback in terms of costs.

It thus appears that the known solutions for producing means of illumination for readers comprise limitations.

An aim of the invention is to make it possible to avoid these limitations concerning illumination means.

“Temperature Control” Aspect

Furthermore, for many applications, such as, for example, oligonucleotide hybridization reactions or enzyme reactions on the chip, it would be advantageous to monitor, with the reader, the parameters of these reactions as a function of the temperature of the chip.

It is thus known practice to provide for the reader table to be temperature-controlled. An example of such a reader will be found in document U.S. Pat. No. 6,329,661.

The fact of thus combining a temperature-controlled table with a chip reader can make it possible to control the temperature of the table by sending a given piece of information.

Another aim of the invention is to improve this device.

In particular, an aim of the invention is to enable the automatic reading of chips under temperature conditions that are optimal for observation of the desired parameters.

In order to achieve the aims disclosed above, the invention provides, according to a first aspect, a device for reading and analyzing chips, comprising:
a table for receiving a chip intended to characterize at least one sample,
means of exciting the molecules or the cells of the chip, after reaction with other molecules,
means of reading and analyzing the molecules subjected to excitation,
   characterized in that the device also comprises:
a unit for controlling the temperature of said table, said control unit being connected to a module (111) consisting of a plurality of Peltier-type heating/cooling elements arranged opposite various spots on the surface of the table,
and at least one table temperature sensor (112) also connected to said control unit.

Preferred, but nonlimiting, aspects of this device are as follows:
the lamp is a mercury lamp,
the laser is a laser whose radiation is centered on a wavelength of the order of 635 nm,
the reader comprises several lasers,
the lasers are centered on the same wavelength,
the excitation means comprise at least one laser associated with a module for scanning of its beam so as to excite the molecules to be analyzed,
the reader comprises two lasers and the modules for scanning of the two lasers control two respective scans of the molecules in two orthogonal directions,
the excitation means comprise at least one laser assembly comprising a laser whose radiation is guided by an optical fiber,
the excitation means comprise two identical laser assemblies,
the excitation means comprise a fixed laser which directs its beam toward two successive mirror assemblies mounted in series, and the movement of which is controlled along two different directions,
the movement of the two mirror assemblies is controlled so as to produce a beam that can follow any desired sequence on the chip,
the excitation means comprise a lamp and a laser whose radiations take the same optical path due to a swinging mirror that can pivot around an axis between two positions so as to direct one of these two radiations toward the chip,
an optical system is interposed between the lamp and the molecules to be excited, whereas the laser excitation takes place by direct illumination of the molecules,
said optical system comprises narrow bandwidth excitation light filters and narrow bandwidth emission light filters, and a beam separator,
the reader also comprises an excitation control unit connected to each of the excitation means in order to control the functioning thereof,
said excitation control unit is capable of selectively controlling the simultaneous or successive illumination of the molecules with the lamp and at least one laser, or the separate excitation of the molecules with the lamp and at least one laser.

The invention also provides a device for reading and analyzing chips, comprising:
a table for receiving a chip intended to characterize at least one sample,
means of exciting the cells or molecules of the chip, after reaction with other molecules or cells,
means of reading the molecules or cells subjected to excitation,
   characterized in that the reader also comprises a temperature control unit.

Preferred, but non-limiting, aspects of this device are as follows:
the table comprises a temperature sensor connected to said temperature control unit.
the reader comprises a heating/cooling module associated with the table and intended to control its temperature, said heating/cooling module being connected to the temperature control unit.
the reader also comprises processing means comprising a microprocessor and connected to the temperature control unit and also to the reading means.
the reader comprises means of storing reference curves of the response of the matches and mismatches of the molecules to the excitation means as a function of the temperature.
the storage means are connected to means for determining a melting temperature for the matches and mismatches of the molecules, from said reference curves.
the temperature control unit is capable of controlling the functioning of the reader according to a “static” mode in which pre-established reference curves of the response of the matches and mismatches of the molecules as a function of the temperature are used to establish a set temperature that can be transmitted, by said temperature control unit, so as to control the temperature of said table.
the temperature control unit is capable of controlling the functioning of the reader according to a “dynamic” mode in which the temperature control unit controls a given change in temperature on the table, and, during this change in temperature:
   the reading means collect, in real time, the response of the molecules associated with the various spots on the chip to the excitation by the excitation means, and transmit said response to processing means,
   storage means store, for each spot on the chip, the change in response of the molecule as a function of the temperature.
the reader comprises processing means capable of establishing, for each molecule, at the end of the storage of said change in response, a diagnosis of state of the molecule.
said diagnosis of state is a match/mismatch diagnosis.

In addition, the invention also relates to a method for using such a device, for reading chips.

Such a method may in particular be a method of hybridization of the oligonucleotides of a chip, which may be carried out using a reader according to one of the aspects above, the method comprising the steps consisting in:
bringing nucleic acid probes corresponding to a target nucleic acid into contact with a biological sample containing single-stranded DNA fragments, so as to carry out a selective hybridization of certain probes with said single-stranded DNA fragments of the sample, by forming duplexes,
reading the duplexes thus formed, the method being characterized in that the method comprises a step consisting of automatic determination of:
the melting temperature for each target nucleic acid in a “match” configuration, and
the melting temperature for each target nucleic acid in a “mismatch” configuration.

Preferred, but non-limiting, aspects of such a method are as follows:
said determination is carried out in the “static” mode using reference curves illustrating the change, as a function of the temperature, in the signal received by means of reading duplexes corresponding, respectively, to matches and to mismatches,
the method comprises controlling the temperature so as to carry out the hybridization at a temperature corresponding to a maximum distinction between match and mismatch,
the method comprises producing said reference curves during a step that precedes the reading step,
the method comprises storing said reference curves,
said determination can be carried out in the “dynamic” mode by controlling a given change in temperature of the samples, and, during this change in temperature, the following are carried out:
   real-time collection of the response of the duplexes associated with the various spots on the chip to the excitation by the excitation means,
   for each duplex, storage of the change in the response as a function of the temperature,
the method comprises, for each duplex, establishing, at the end of the storage of said change in response, a diagnosis of match/mismatch of the duplex.

Other characteristics and advantages of the invention emerge upon reading the following description with the examples and the figures for which the legends are represented below:

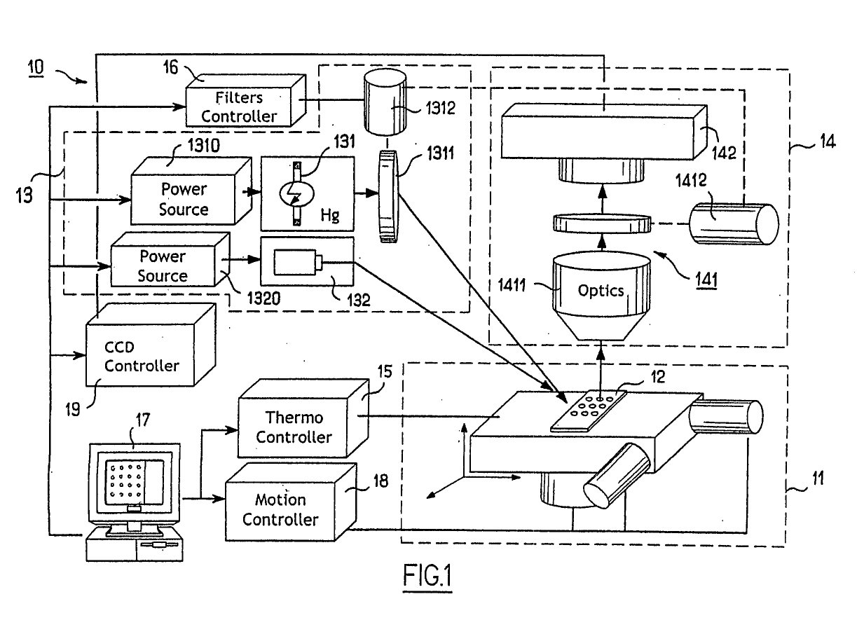

FIG. 1 is a diagram of the principle of a reader according to the invention.

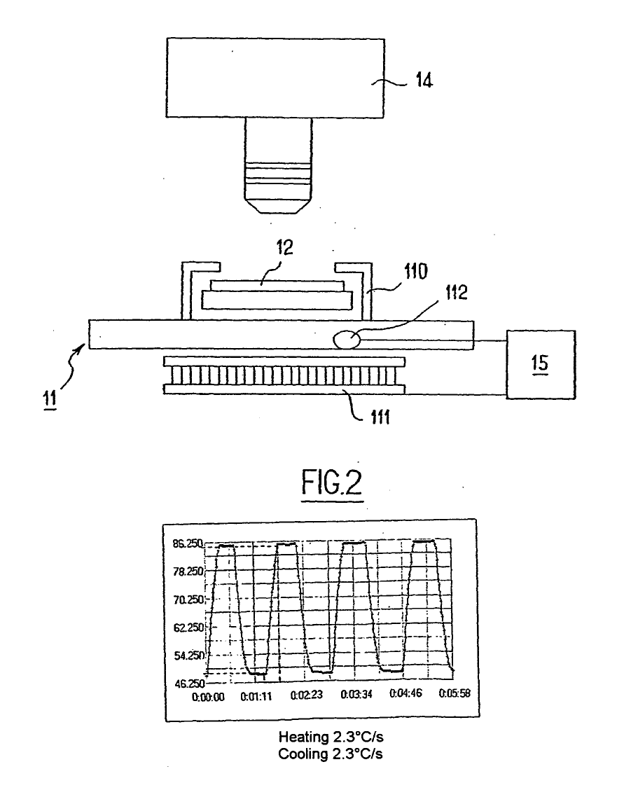

FIG. 2 comprises:
in its upper part, a diagram of the principle of the table of a reader according to the invention, detailing the temperature control means,
in its lower part, a graph representative of a possible change in temperature (and revealing in particular that rapid changes in temperature—of the order of 2.3° C./s—are possible with the device according to the invention),

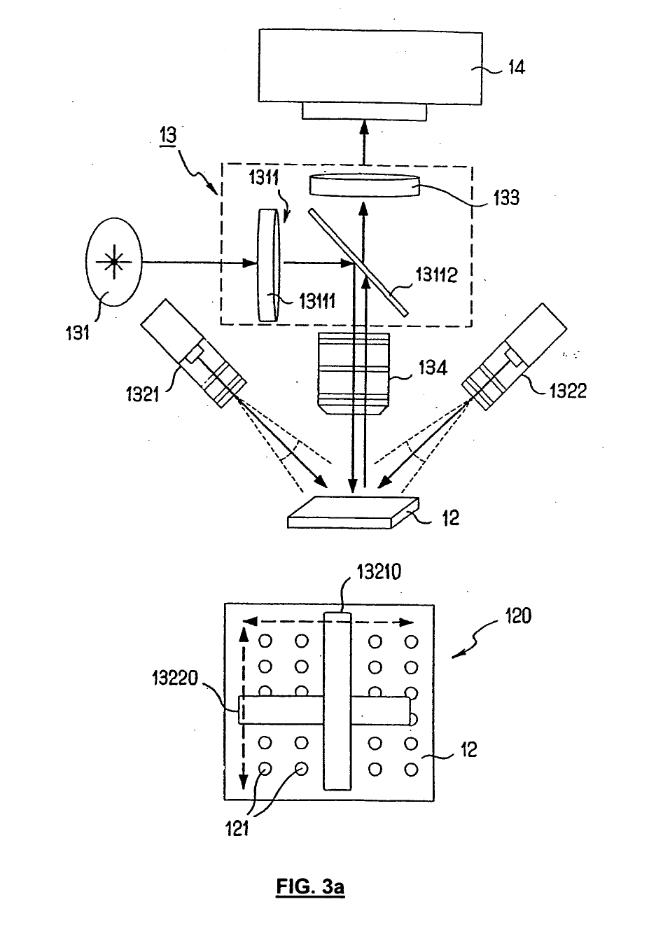

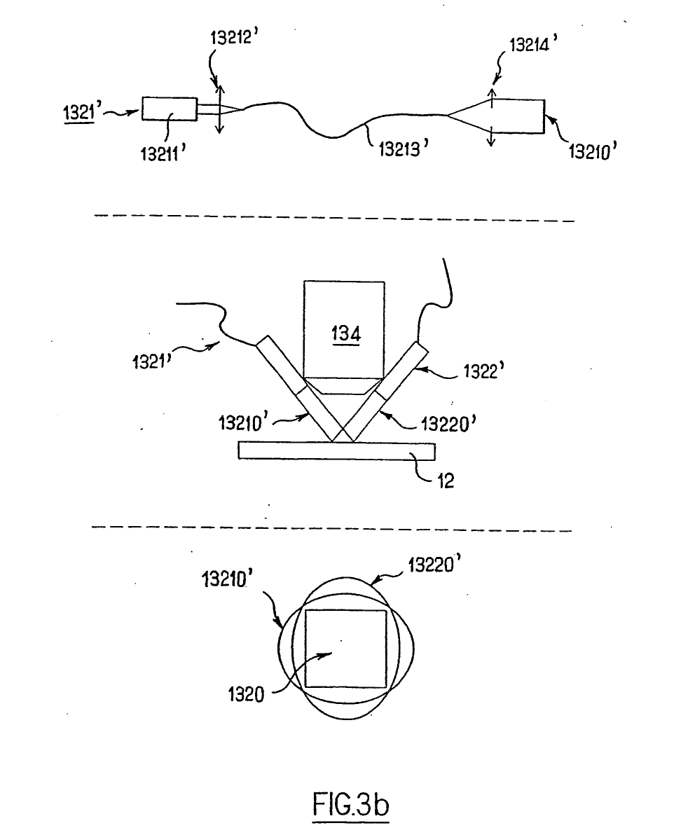

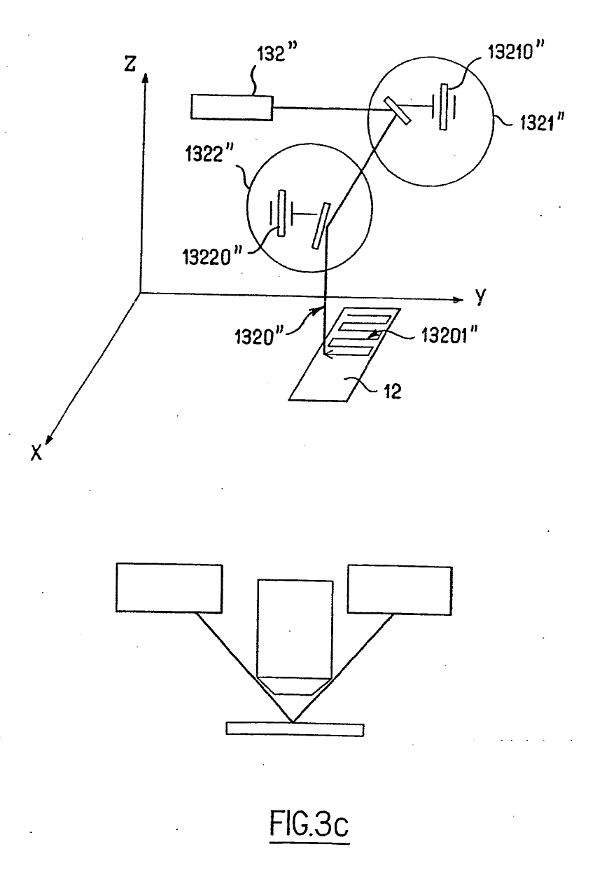

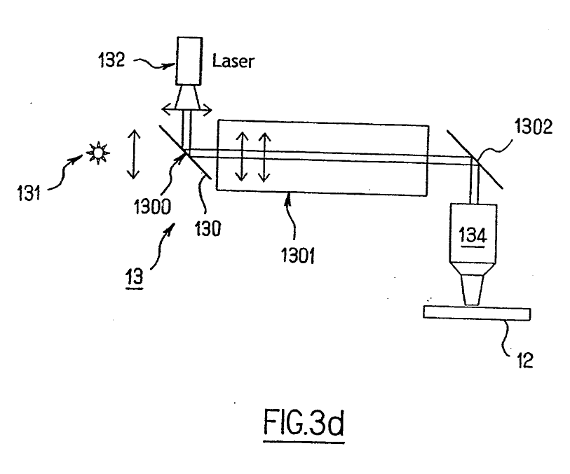

FIGS. 3a to 3d are diagrams illustrating four variants of implementation of all or part of the excitation light means of such a reader, FIG. 3a also comprising an illustration of the scanning of a chip by the light sources of the excitation means,

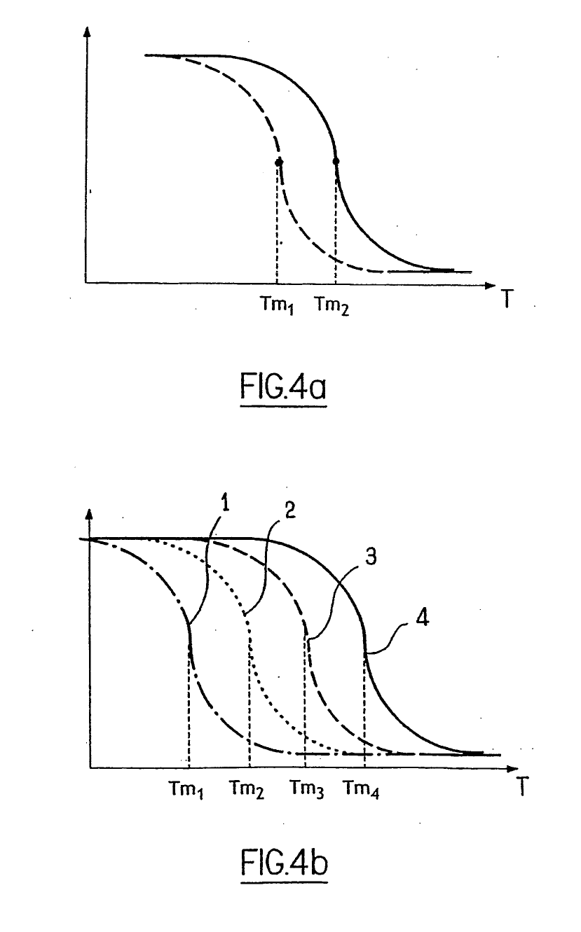

FIGS. 4a and 4b are graphs relating to an application of the invention to molecular hybridization:
FIG. 4a is a reference curve illustrating the change, as a function of the temperature, of the signal at all points of a chip, received by the reading means, for the same DNA sequence in the match configuration and in the mismatch configuration,
FIG. 4b illustrating a “dynamic” mode of implementation of the invention, in which curves of the type of those of FIG. 4a are constructed for several DNA sequences,

FIG. 5 is a diagram of a reaction for immobilizing probes on a slide having an aldehyde function (Super Aldehyde slide from TéléChem). Aldehyde groups are covalently attached to the glass support of the biochip (rectangle). The NH₂ function of the DNA molecule attacks the aldehyde group so as to form a covalent bond (central figure). The bond is stabilized by a dehydration reaction (drying in a slightly humid atmosphere), which results in the formation of a Schiff's base,

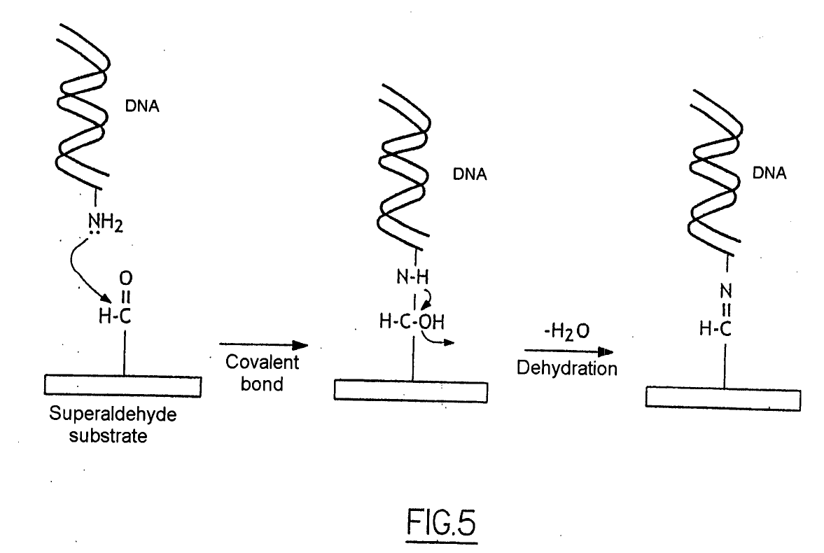

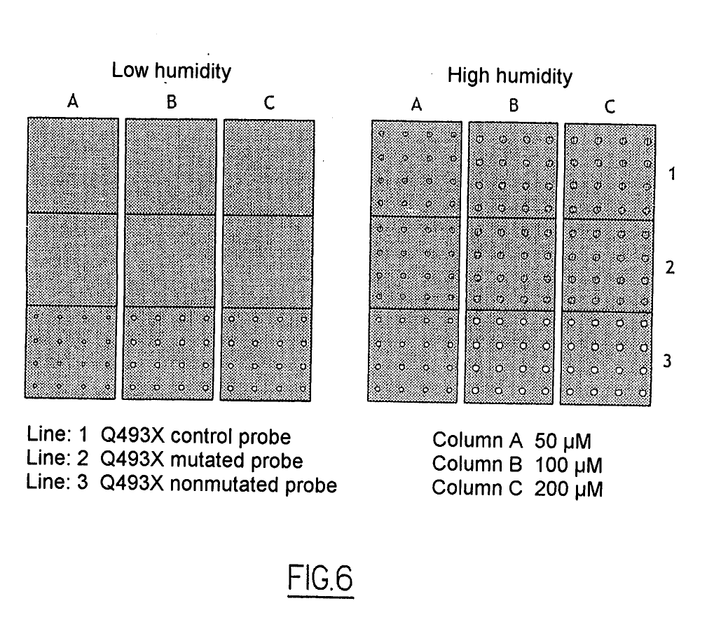

FIG. 6 illustrates images of the Cy3 fluorescence of the hybridization of a mixture of wild-type oligonucleotides Q493X-Cy3 and mutated oligonucleotides Q493X-Cy5 on a biochip comprising the corresponding probes spotted at various concentrations (50, 100 and 200 μM) and then immobilized with various conditions (low and high humidity). The hybridization is carried out in 6×SSC, 0.2% SDS, 0.2 mg/ml BSA, at ambient temperature for 12 hours. The concentration of the oligonucleotides is 0.5 μM. The washing of the biochip after hybridization is carried out in 6×SSC, 0.2% SDS for 5 minutes at ambient temperature, followed by 2 minutes at ambient temperature, in 2×SSC,

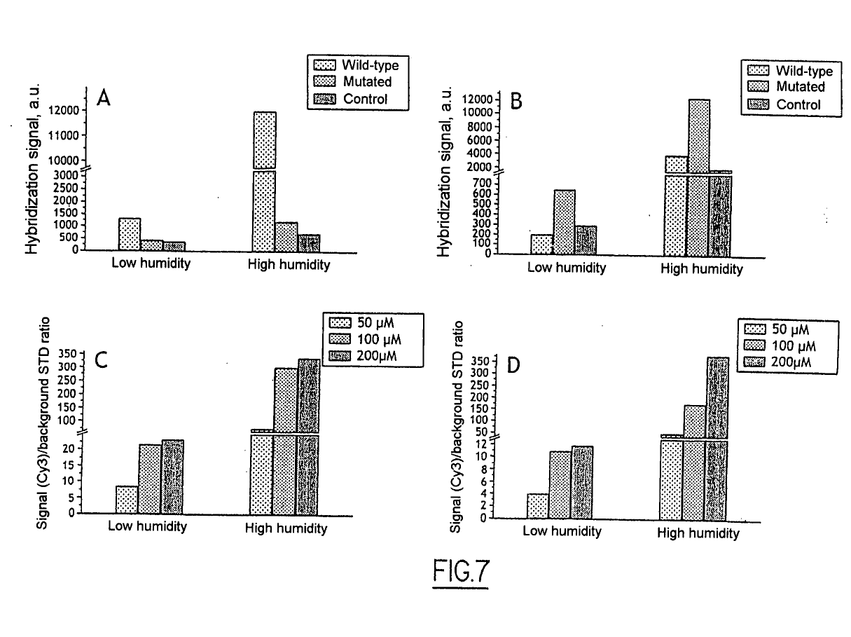

FIG. 7 shows fluorescence signal intensities and noise/signal ratio corresponding to the hybridization of a solution of oligonucleotides wtQ493X-Cy3 and mutQ493X-Cy5 for chips comprising probes corresponding to various concentrations (50, 100 and 200 μM) and immobilized under various conditions (low and high humidity),

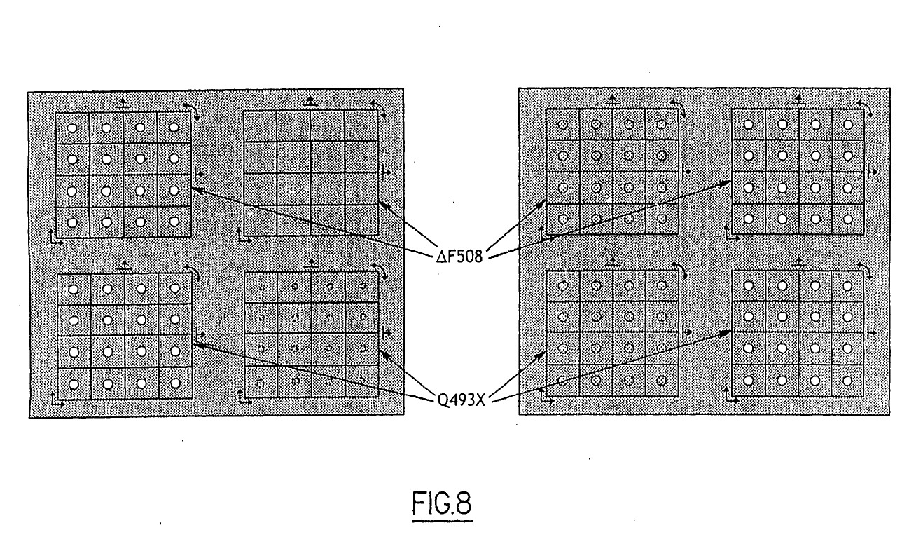

FIG. 8 represents fluorescence images corresponding to the hybridization of Cy3-labeled wild-type oligonucleotides ΔF-508 and Cy5-labeled mutated oligonucleotides Q493X.

### DETAILED DESCRIPTION OF THE INVENTION

With reference to FIG. 1, a reader 10 according to the invention has been diagrammatically represented.

The reader 10 comprises:
a table 11 for receiving a chip 12,
excitation means 13,
reading means 14 (i.e. means of observing the molecules of the chip, in particular in response to an excitation emitted by the means 13),
command and control means.

Table 11

Table 11 is represented in detail in the upper part of FIG. 2.

This table conventionally comprises means 110 for holding a chip 12.

These means may comprise a chamber—for example, a hybridization chamber.

The table 11 is associated with a heating/cooling module 111 capable of controlling the temperature of the table.

More precisely, the module 111 consists of a plurality of Peltier-effect heating/cooling elements. These Peltier elements are integrated into the thickness of the table 11.

Each of these Peltier elements is located opposite a spot on the surface of the table 11—and therefore on the chip 12 which is carried by the table.

Said spots are adjacent to one another, and the combination thereof covers the entire surface of the chip.

It may be advantageous to envision that these spots correspond to the spots on the chip that will receive the probes (see later in the text).

The module 111 is, moreover, connected to a temperature control unit 15 which produces a set temperature and transmits it to the module 111 so that the latter adjusts the temperature of the table accordingly, with a temperature variation rate that depends on the physicochemical phenomenon observed.

More precisely, the control unit produces an individual set temperature intended for each Peltier element of the module 111.

These Peltier elements are extremely precise—they typically provide a set temperature with a precision of the order of 0.01° C.

The module 111 formed by the combination of these Peltier elements is associated with a heat exchange module, so as to allow the heating/cooling of the table 11.

This heat exchange module can function by circulation of air or of fluid.

It is thus possible to finely control the temperature at any spot on the table.

It is in particular possible, in this way, to ensure that the temperature is strictly the same at all the spots on the table 11.
This is further promoted by the fact that the Peltier elements are very reactive to changes in set temperature (increase or decrease).

These elements can therefore, with precision, provide rapid temperature changes (typically, with a precision of the order of 0.01° C., and with a rate of change of a few degrees per second).

It may thus be desired to implement a “rapid” temperature change—change of the order of a few degrees per second, used, for example, in reactions of PCR type (acronym of polymerase chain reaction).

It may also be desired to implement a “slow” change (change of the order of a few degrees per minute—used, for example, in reactions of DNA strand fusion type, with a view to the dissociation thereof).

In order to be able to implement these various types of changes, at least one correspondence table is stored in a memory of the device that can be accessed by the unit 15 (for example, a memory of the computer 17 which will be described).

It will be noted that the rate depends not only on the type of reaction envisioned, but also on the type of probe used, and on the sample that it is desired to characterize.

In this regard, the correspondence table(s) also take into account these parameters.

In addition, the user of the device can thus enter into an appropriate interface (keyboard or the like) connected to the unit 15 and/or to the computer 17, the parameters (in particular, type of reaction, probe, sample) as a function of which a program associated with the correspondence table(s) will automatically select the set temperature change to be transmitted to the module 111.

A temperature sensor 112 is, moreover, integrated into the table, to record its effective temperature and transmit it to the temperature control unit 15 to which this sensor is also connected.

In this way, the temperature of the spots on the chip is controlled by the temperature control unit 15, and this temperature of the spots on the chip is also known in real time by the temperature control unit.

It is, moreover, possible to envision several temperature sensors 112, opposite groups of spots or even opposite each of the individual spots on the chip.

The sensor(s) 112 is (are) integrated into the table 11.

In addition, as will be seen in greater detail later in this text (in particular with respect to the dynamic mode), this (these) temperature sensor(s) make(s) it possible to record the temperature parameters associated with the functioning of the device, and also to regulate this functioning.

Excitation Means 13

The excitation means 13 comprise two types of light sources:
a broad-spectrum lamp 131—preferably a mercury lamp,
at least one laser 132.

This laser emits according to a wavelength that makes it possible to excite the labels normally used, and the excitation spectrum of which does not correspond to the emission spectrum of the lamp 131.

In the preferred embodiment in which the lamp is a mercury lamp—which does not make it possible to excite the Cy5 label—the laser is a conventional red laser that emits around a line centered on 635 nm or other lasers that enable excitation of the Cy5 molecule.

In this way, all the luminous labels normally used can be excited by the excitation means 13.

Furthermore, the use of a laser does not significantly increase here the cost price of the reader, since this type of laser is extremely common and inexpensive.

The excitation means 13 also comprise a respective power source 1310, 1320 for each type of light source.

The means 13 also comprise an optical system 1311 interposed between the lamp 131 and the table (and therefore between the lamp and the molecules of the chip).

As represented in FIG. 3a, this optical system comprises an excitation filter 13111, and a beam separator 13112 making it possible to:
direct toward the chip the radiation derived from the lamp and from the filter 13111,
and direct toward the reading means 14 the signal derived from the chip in response to the excitation received from the lamp (or from the laser(s) of the excitation means).

It is specified that said optical system can also comprise narrow bandwidth excitation light filters and narrow bandwidth emission light filters (at least 2 and up to 8) and a beam separator.

The radiations directed toward the chip, and derived from this chip, can also pass through an objective 134.

The excitation means 13 also comprise interfering filter change means 1312 (represented in FIG. 1), which are connected to the filter 13111 and to filter control means 16.

It is therefore understood that the excitation of the molecules of the chip by the radiation derived from the lamp occurs via an optical system.

As regards the excitation of the molecules of the chip by the radiation derived from the laser, it occurs directly, no element being interposed between the laser and the chip.

In the variant that is more particularly illustrated in FIG. 3a, the excitation means comprise two lasers 1321 and 1322. These two lasers are identical.

Each laser is associated with a module (not represented) for scanning the biochip.

When the reader comprises only one laser, this laser is itself also associated with a module that performs this function, in a beam of parametrable geometry.

In order to effectively cover a field of vision corresponding to the spots on the chip that it is desired to characterize, and to evenly illuminate this field of vision by laser, the two scanning modules impose two respective scans of the molecules in two orthogonal directions.

This type of scanning is illustrated in the lower part of FIG. 3a.

The two bands 13210 and 13220 represent the respective beams of the two lasers 1321 and 1322.

These two beams have an elongated cross section, the directions of elongation of the two beams being orthogonal.

Each of these directions can be aligned on one of the two directions of alignment of the spots on the chip, these spots generally forming a rectangular matrix.

Each beam is moved by the scanning module of its associated laser over the field of vision 120, in a direction orthogonal to the direction of elongation of the beam.

FIG. 3b represents a second variant of implementation of the lasers of the excitation means 13. These lasers are intended to be used in place of the lasers 1321 and 1322.

In this variant, the laser excitation is directed toward the chip 12 by two identical assemblies 1321′ and 1322′ which produce two respective beams 13210′ and 13220′.

One of these assemblies, denoted 1321′, is represented in the upper part of FIG. 3b.

This assembly comprises a laser 13211′ associated with an output lens 13212′ that directs the flux derived from the laser toward an optical fiber 13213′.

This fiber itself transmits the radiation to another lens, marked 13214′, which is mounted fixed relative to the chip and directs the beam 13210′ toward it.

The lower part of FIG. 3a represents the impact of the two beams 13210′ and 13220′ on the chip and on the field of illumination 1320 thus defined.

The lasers can thus be off-center.

FIG. 3c represents a third variant of the laser(s) system, in which at least one fixed laser 132″ directs its beam toward two successive mirror assemblies mounted in series, marked 1321″ and 1322″.

Each of these mirror assemblies comprises a mirror whose orientation is controlled by a respective piezoelectric actuator 13210″, 13220″.

More precisely, each mirror is thus moved along a respective axis, which responds to one of the transverse axes X, Y of the chip 12.

The beam 1320″ derived from the two mirrors thus, on the chip, takes a path 13201″ that can follow any desired sequence along X, Y.

Here again, this laser system can replace the lasers 1321, 1322 of FIG. 3a.

Finally, FIG. 3d illustrates another variant of implementation of the excitation means 13, which corresponds to an alternative to the means represented in FIG. 3a.

This FIG. 3d represents a mercury lamp 131 and a laser 132.

The laser and the lamp are each associated with a respective output lens.

In this variant, the respective radiations derived from the laser and from the lamp take the same optical path, due to a swinging mirror 130 capable of pivoting around an axis 1300 between two positions so as to direct one of these two radiations toward a series of lenses 1301 and a return mirror 1302 for directing the radiation toward the optic 134 and the chip 12.

The means of controlling the swinging of the mirror 130 can control any sequence making it possible to illuminate the chip with the two types of radiation (laser and lamp), for example by pivoting between its two positions with a desired frequency.

It is specified that, in all the variants presented above, the excitation means may comprise a laser, or several identical lasers.

Reading Means 14

The reading means 14 comprise an optical system 141 for acquiring the image of the field 120 of the chip 12, it being possible, moreover, for this chip to be moved relative to the rest of the reader by means of a controlled movement of the table 11.

To this effect, the reading means also comprise registering means for coordinating the movements of the table 11.

The optical system 141 thus comprises a first acquisition optic 1411, and a filter 1412 interposed between this first optic and a CCD camera 142.

The optical system 141 also comprises filter changing means 14120 (represented in FIG. 1), which are connected to the filter 1412 and to the filter control means 16.

Control and Command Means

The means for controlling and commanding the reader comprise, besides the temperature control unit 15 and the filter control means 16 already mentioned, a computer 17 which manages the functioning of all the components of the reader.

The computer is connected to the following elements in such a way as to transmit functioning instructions to them and/or to receive information from them:
power sources 1310 and 1320—in this regard, the computer performs the function of an excitation control unit. It is specified that the computer can selectively control:
   the simultaneous illumination of the molecules of the chip with the lamp and at least one laser,
   or the separate excitation of the molecules with the lamp and at least one laser,
temperature control unit 15,
filter control means 16,
and the other control and command elements that follow.

The means of controlling and commanding the reader thus also comprise:
a unit 18 for controlling the movements of the table 11, connected to this table and to the computer 17,
a unit 19 for controlling the camera 142, and acquisition of the images by this camera, according to variable modes that include the real-time mode for following a dynamic phenomenon, or with a pause time for increasing the signal-to-noise ratio of the images with spots (hybridization signals) of very low intensity.

Functioning of the Reader

The structure of the reader according to the invention has been described above in detail. Certain aspects of the functioning thereof, in particular with regard to the excitation of the molecules of the chip, have also been dealt with. The functioning of this reader will now be described in detail, with regard to temperature control.

More precisely, this functioning will be described on the basis of a preferred application of the invention, which is the hybridization of oligonucleotides of a chip with the single-stranded DNA fragments derived from a biological sample.

It is, however, specified that the reader according to the invention can be used for other applications—for example, for carrying out enzymatic reactions (in particular of the ligase, PCR, simple oligonucleotide extension, etc., type), for screening ligands.

Returning to the hybridization application, a biological sample, for example derived from a patient, is studied in order to detect therein certain genetic characteristics. The characteristic sought may, for example, be the possible presence of mutations in a specific nucleic acid sequence, such as, for example, the CFTR gene.

The method begins conventionally, with the preparation of a chip, by constituting, at the various spots of the chip, nucleic acid probes constituted using nucleotides corresponding to a target nucleic acid.

These probes are intended to be hybridized with the sample containing single-stranded DNA fragments.

The single-stranded DNA fragments are, moreover, obtained in a known manner, in particular by PCR amplification. They are combined with a label so as to allow them to be detected by the reading means of the reader, after hybridization of these fragments with the probes of the chip.

Said probes were then brought into contact with the sample so as to carry out a selective hybridization of certain probes with said single-stranded DNA fragments of the sample, so as to constitute duplexes.

It is specified that not all the probes hybridize with the DNA strands of the sample.

In fact, each nucleic acid probe will hybridize preferentially with its target nucleic acid.

In addition, certain probes thus correspond to a nucleic acid with no mutation, whereas others correspond to a nucleic acid comprising a given mutation.

During this hybridization step, duplexes form for the probes which are effectively hybridized.

The fact that a probe hybridizes correctly means that the sample contains single-stranded DNA fragments corresponding to the target nucleic acid of said probe.

A probe that hybridizes in this way thus corresponds to a “match”-type duplex after the hybridization step.

Furthermore, a probe that does not hybridize—or that hybridizes poorly—with the single-stranded DNA fragments of the sample corresponds, after the hybridization step, to a “mismatch”-type duplex or even to a nonhybridized single strand.

The temperature is an important parameter of this hybridization step.

This is because, for each target nucleic acid, there exists:
a melting temperature Tm1 for a duplex in the “mismatch” configuration, and
a melting temperature Tm2 for a duplex in the “match” configuration.

The melting temperature corresponds to the temperature at which the two strands of half the duplexes separate from one another.

Tm1 is less than Tm2, as illustrated in FIG. 4a.

In addition, it is desirable, for a given target nucleic acid, to carry out the hybridization step at a temperature corresponding to a maximum distinction between match and mismatch.

The “match” and “mismatch” duplexes can thus in fact be selectively visualized with the reading means of the chip reader.

This desired temperature is between Tm1 and Tm2.

In the case of the known hybridization methods, it is generally necessary to repeat several hybridizations in order to obtain a temperature close to this desired temperature.

In the case of the invention, the control of the temperature by means of the temperature control unit 15 makes it possible to avoid this drawback.

More precisely, this application of the invention can be carried out according to two modes: a “static” mode and a “dynamic” mode.

In these two modes, the following will be automatically determined:
the melting temperature of each target nucleic acid in a “match” configuration, and
the melting temperature of each target nucleic acid in a “mismatch” configuration.

Static Mode

This mode is very suited to the case of a chip in which the probes correspond to the same target nucleic acid or to target nucleic acids that have similar melting temperatures.

In this mode, said determination of melting temperatures is carried out beforehand, such that these temperatures are known before performing the characterization.

These temperatures may be known to the operator, who carries out this characterization and who consequently enters a set temperature value into the device (using an interface connected to the computer 17, or directly to the unit 15).

These temperatures may also be stored in a memory of the reader, which memory is connected to said unit 15.

The temperature of the chip is thus controlled so as to carry out the hybridization at a temperature corresponding to a maximum distinction between match and mismatch.

It is specified that the melting temperatures can also be determined by the reader (see dynamic mode hereinafter) and stored for implementation of the static mode.

During such a determination a priori of the melting temperatures, reference curves equivalent to those of FIG. 4a are produced.

The reference curves can thus be formed during a step that precedes the reading step.

In this case, the reader is used to record the response of the probes to single-stranded fragments of known type (fragments corresponding to a target nucleic acid without mutation, and with mutation), when the temperature varies continuously under the effect of the control of the unit 15.

In addition, these curves can be stored, for example in the computer 17.

Dynamic Mode

This mode is particularly well suited to the case of a chip in which the probes correspond to target nucleic acids whose “match” configurations have very different melting temperatures.

In this mode, a change in temperature of the chip (for example, constant increase or constant decrease) is controlled in such a way as to pass through the melting temperatures of the various target nucleic acids of the various probes.

This change is obtained by sending an appropriate piece of information from the unit 15 to the Peltier elements of the module 111 associated with the table.

During this change in temperature:
the reading means 14 collect, in real time, the response of the duplexes associated with the various spots on the chip, to the excitation by the excitation means 13, and transmit said response to the computer 18,
for each spot on the chip, the evolution in the response of the duplex as a function of the temperature is stored in a memory of the computer 18.

In addition, the presence of at least one temperature sensor 112 in the table makes it possible:
to record, throughout the change, the successive temperature values (this taking place at the various sites on the table—and therefore on the chip—where various sensors 112 are arranged). This makes it possible to characterize the change in the response of the duplex as a function of the temperature,
to control the temperature on the surface of the table. In this regard, the sensor(s) 112 allow(s) a true regulation of temperature, beyond a simple “blind” control that would be satisfied with transmitting a set temperature to a heating element.

It is recalled that since Peltier elements are very reactive and allow rapid temperature changes, applications of the PCR type can also be envisioned.

In addition, the combination of discrete

Peltier-type heating/cooling elements with at least one temperature sensor thus makes it possible:
to finely control the temperature distribution at all the spots on the table (and therefore on the chip),
and to perform a true regulation that goes beyond a simple control.

The computer thus constructs, for each spot on the chip, a curve that illustrates the change in response of the probe as a function of the temperature, as represented in FIG. 4b, which illustrates the very simple case of a four-spot chip (curves 1, 2, 3 and 4).

The probes are distributed in pairs, one probe of the pair corresponding to a target nucleic acid without mutation, the other probe corresponding to the same target nucleic acid with a mutation.

The response of the two probes of each pair will therefore correspond to two curves similar to the two reference curves of FIG. 4a.

In addition, it will be possible, by analyzing the curves for each pair of probes, to determine the “match” probe and the “mismatch” probe.

To this effect, the computer comprises a program capable of establishing, for each spot on the chip, once said change in response has been stored, a diagnosis of state of the probe associated with this spot.

### EXAMPLE OF IMPLEMENTATION OF THE INVENTION

The chip reader according to the invention makes it possible to read DNA chips. An object of the present invention is therefore also to provide a DNA chip composed of many oligonucleotides (or probes) corresponding to or comprising fragments of a wild-type or mutated gene, in particular of the human CFTR gene (Cystic Fibrosis Transmembrane conductance Regulator). Such a chip is particularly useful for detecting mutations in the human CFTR gene and diagnosing cystic fibrosis.

Cystic fibrosis is one of the most common autosomal recessive diseases in the Caucasian population since it affects approximately one person out of 2000 births in North America (Boat et al., The metabolic basis of inherited disease, 6th Ed. pp 2649-1680, McGraw Hill, New York, 1989).

Cystic fibrosis has been associated with mutations in the CFTR gene that extends over 250 kb and comprises 27 exons. Since the characterization of the gene in 1989, many genetic analyses have been carried out in order to define the spectrum of mutations of this gene. There is a great variety of said mutations, and more than 850 mutations have thus been characterized. However, one mutation is by itself found to be present in 50% of patients; it is the Delta F508 mutation. Most of the other mutations are present with a low incidence in patients (1-5%).

This observation explains the complexity of development of the available diagnostic tests. One diagnostic test thus allows the detection of approximately 30 different mutations, using ligation reactions in a tube (OLA, Perkin Elmer).

Other approaches involving DNA chip technologies have been developed for identifying the mutations in the human CFTR gene. Mention should thus be made of U.S. Pat. Nos. 6,027,880; 5,837,832; 5,972,618 and 5,981,178. However, to date, no test makes it possible to detect the most common mutations in the CFTR gene in a simple, rapid, effective and reliable manner. This is the problem that the present invention also proposes to solve, by developing a DNA chip for detecting mutations in the human CFTR gene, which chip can be used with the reader according to the invention.

Characteristics of the CFTR Chip

The present invention therefore provides an array of oligonucleotides or DNA chip (CFTR chip) for detecting mutations in the human CFTR gene. This array comprises a solid support to which a plurality of different oligonucleotides (the probes) are attached in such a way that said oligonucleotides hybridize effectively with complementary oligonucleotides or polynucleotides (i.e. with target oligonucleotides or polynucleotides present in the biological sample to be tested, or else derived therefrom), and in such a way that said oligonucleotides having different nucleotide sequences are attached to said solid support at separate spots such that oligonucleotides having a specific nucleic acid sequence hybridize effectively with complementary target oligonucleotides or polynucleotides at a specific location on said solid support.

Said array is characterized in that it comprises at least one pair, at least two pairs, at least three pairs, at least four pairs, at least five pairs of oligonucleotides, at least 6, at least 7, at least 8, at least 9, at least 10, at least 15 pairs of oligonucleotides, each pair of oligonucleotides consisting of an oligonucleotide corresponding to or comprising an oligonucleotide fragment of the wild-type (wt) CFTR gene and an oligonucleotide corresponding to or comprising an oligonucleotide fragment of the mutated (mut) CFTR gene and a negative control oligonucleotide (cont) that forms a “mismatch” duplex with both the mutated and wild-type CFTR gene.

Two sets of probes, approximately 20 nt (depending on the base composition) and 15 nt in length, are produced.

Preferably, said set (wild-type/mutated/control) is selected from the group composed of:

Set No. 1: (this set has no control probe)

| | | |
|---|---|---|
| TAGGAAACACCAAAGATGATATTT | (SEQ ID N°1) | 24 mer |
| CATAGGAAACACCAATGATATTTT | (SEQ ID N°2) | 24 mer |
| Set No. 2: | | |
| AGGAAAACTGAGAACAGAATG | (SEQ ID N°3) | 21 mer |
| AGGAAAACTAAGAACAGAATG | (SEQ ID N°4) | 21 mer |
| AGGAAAACTTAGAACAGAATG | (SEQ ID N°5) | 21 mer |
| Set No. 3: | | |
| ACCTTCTCCAAGAACTATATTG | (SEQ ID N°6)/ | 22 mer |
| ACCTTCTCAAAGAACTATATTG | (SEQ ID N°7) | 22 mer |
| ACCTTCTCTAAGAACTATATTG | (SEQ ID N°8) | 22 mer |
| Set No. 4: | | |
| TTCTTGCTCGTTGACCT | (SEQ ID N°9)/ | 17 mer |
| TTCTTGCTCATTGACCT | (SEQ ID N°10) | 17 mer |
| TTCTTGCTCCTTGACCT | (SEQ ID N°11) | 17 mer |
| Set No. 5: | | |
| TGGTTGACCTCCACTCA | (SEQ ID N°12)/ | 17 mer |
| TCGTTGATCTCCACTCA | (SEQ ID N°13) | 17 mer |
| TCGTTGAACTCCACTCA | (SEQ ID N°14) | 17 mer |
| Set No. 6 | | |
| ACCTTCTCCAAGAAC | (SEQ ID N°15)/ | 15 mer |
| ACCTTCTCAAAGAAC | (SEQ ID N°16) | 15 mer |
| ACCTTCTCTAAGAAC | (SEQ ID N°17) | 15 mer |
| Set No. 7: | | |
| CTTGCTCGTTGACCT | (SEQ ID N°18/) | 15 mer |
| CTTGCTCATTGACCT | (SEQ ID N°19) | 15 mer |
| CTTGCTCCTTGACCT | (SEQ ID N°20) | 15 mer |
| Set No. 8: | | |
| TCGTTGACCTCCACT | (SEQ ID N°21/) | 15 mer |
| TCGTTGATCTCCACT | (SEQ ID N°22) | 15 mer |
| TCGTTGAACTCCACT | (SEQ ID N°23) | 15 mer |

Pair No. 1 makes it possible to detect the most common mutation in the CFTR gene which is the delta F508 mutation located in exon 10. This mutation corresponds to a deletion of 3 base pairs (AGA codon), which results in the deletion of amino acid 508 from the CFTR protein.

Set No. 2 makes it possible to detect the mutation Q493X in exon 10 of the CFTR gene. This mutation corresponds to a G→A substitution at position 493, which results in the appearance of a nonsense mutation.

Set Nos. 3 and 6 make it possible to detect the mutation G542X in exon 11 of the CFTR gene. This mutation corresponds to a C→A substitution at position 542, which results in the appearance of a nonsense mutation.

Set Nos. 4 and 7 make it possible to detect the mutation R553X in exon 11 of the CFTR gene. This mutation corresponds to a G→A substitution at position 553, which results in the appearance of a nonsense mutation.

Set Nos. 5 and 8 make it possible to detect the mutation G551D in exon 11 of the CTFR gene. This mutation corresponds to a C→T substitution at position 551, which results in the substitution of a glycine at position 551 with an aspartic acid.

Preferably, the present CFTR chip comprises at least all the five pairs of oligonucleotides above. The CFTR chip according to the invention is characterized in that the oligonucleotides that make it up have, when they are in double-stranded form, melting temperatures (Tm) that are similar, and preferably between approximately 55 and 85° C., approximately 65 and 75° C., preferably in the region of approximately 70° C. (in 1M NaCl). Thus, the oligonucleotide of sequence:

Optionally, the CFTR chip according to the invention also comprises negative control oligonucleotides, i.e. probes that form hybrids with mismatches with all the targets studied.

The choice of sequences of the oligonucleotides immobilized on the solid surface is of great importance in terms of obtaining good differentiation between the hybrids with mismatch and without mismatch. Thus, one of the important parameters lies in the design of the probes in such a way as to avoid the probability of formation of secondary intramolecular structures and also the probability of formation of intermolecular complexes by the immobilized probes, since these structures considerably decrease the effectiveness of hybridization of the target to the probe, and the distinction between the hybrids with or without mismatch. Thus, the requirements relating to the characteristics of the oligonucleotides are achieved through the choice of the nucleic acid sequence of the oligonucleotides, in particular of its length and of its base composition, and/or through the addition of additional nucleotides in order to modify the Tm or the possibility of formation of intramolecular structures and of intermolecular complexes. These requirements, that are difficult to satisfy, justify the inventive step of the present invention.

The CFTR chip according to the invention, coated with pairs of oligonucleotide probes, is characterized in that said oligonucleotide probes are deposited in the form of spots, the average diameter of which is between 20 μm and 500 μm, preferably between 50 μm and 200 μm.

The average distance between the center of each of the spots of oligonucleotide probes is variable and depends on the chip, but they are defined so as not to affect the hybridization reactions on two neighboring spots. Nevertheless, this distance is preferably between 50 μm and 80 μm, between 1000 μm and 2500 μm, or between 100 μm and 500 μm. At each spot, multiple copies of the same oligonucleotide are preferably deposited. Thus, each spot preferably comprises at least 1, at least 2, or frequently at least 16, of the same oligonucleotide.

The number of spots on the chip according to the invention is variable and depends on the number of pairs of oligonucleotides spotted on the solid surface. Preferably, it is a medium-density array, i.e. with a restricted number of spots. Thus, the number of said spots is at least 2 per cm², at least 4 per cm², at least 6 per cm², at least 8 per cm², at least 10 per cm², at least 50 per cm², at least 100 per cm², at least 500 per cm², at least 1000 per cm², at least 10 000 per cm², at least 50 000 per cm², or at least 100 000 per cm².

The solid support of the CFTR chip according to the invention is chosen from solid supports made of glass, plastic, Nylon®, Kevlar®, silicone, silicon or polysaccharides. Preferably, the solid support is a glass slide, more preferably a glass microscope slide.

It is preferably a slide functionalized with an aldehyde. By way of example of commercially available 2D glass slides. The chip according to the invention is preferably chosen from the 2D-microarray or 3D micro-array type. According to a first embodiment, it is a 2D-chip in which the probes are preferably attached by amino and aldehyde chemistry according to the methods known to those skilled in the art. Unmodified DNA and amino-modified DNA can thus, respectively, hybridize on these substrates by covalent bonding.

Mention may be made of SuperAldehyde substrate-type slides for the immobilization of amino-modified DNA or SuperAmine substrate-type slides for the immobilization of unmodified DNA (for example, the TeleChem Array It slides—registered trademark).

The general principle of the immobilization of the amino-modified DNA on the commercial aldehyde-functionalized slide is illustrated in FIG. 5.

FIGS. 6 and 7 illustrate the effect of modifying the protocol so as to perform coupling of the DNA with a SuperAldehyde surface under high humidity (humidity in a closed plastic dish having a volume of approximately 700 cm³, half-filled with water).

This modification allows an increase in the immobilization efficiency and in the signal/noise ratio.

According to a second embodiment, the chip is a hydrogel-based 3D-chip, such as the 3D-link activated slides™ (Motorola) which have the advantage (i) of greater probe immobilization efficiency, and thus better hybridization signal intensity; (ii) of better distinction between the hybrids with or without mismatches (Livshits and Mirzabekov, 1996, Theoretical analysis of the kinetics of DNA hybridization with gel-immobilized oligonucleotides. Biophys. J. November; 71(5) 2795-2801).

Preferably, the oligonucleotides of the CFTR chip that are described above are spotted and attached to the solid surface in the form of single-stranded DNA, by one of the ends of the oligonucleotides. Preferably, it is the 3′-end.

Use of the CFTR Chip

Procedure

Materials and Methods: Hybridization Conditions

Hybridization of Oligonucleotides and Chip

A sample prepared from a mixture of:
nonmutated (wild-type or wt) oligonucleotides labeled with a Cy3 fluorophore, and
mutated (or mut) oligonucleotides labeled with a Cy5 fluorophore

was hybridized on a chip:

| | |
|---|---|
| AAATATCATCTTTGGTGTTTCCTA-Cy3 | (ΔF508-wt) |
| AAAATATCATTGGTGTTTCCTATG-Cy5 | (ΔF508-mut) |
| CATTCTGTTCTCAGTTTTCCT-Cy3 | (Q493X-wt) |
| CATTCTGTTCTTAGTTTTCCT-Cy5 | (Q493X-mut) |
| AATATACTTGGAGAAGGT-Cy3 | (G542X-wt) |
| ACCTTCTCAAAGTATATT-Cy5 | (G542X-mut) |
| AGGTCAACGAGCAAGAA-Cy3 | (R552X-wt) |
| AGGTCAATGAGCAAGAA-Cy5 | (R552X-mut) |
| TGAGTGGAGGTCAACGA-Cy3 | (G551D-wt) |
| TGAGTGGAGATCAACGA-Cy5 | (G551D-mut) |

FIG. 8 shows the hybridization images corresponding to the hybridization of the oligonucleotides ΔF508-wt, ΔF508-mut, Q493-wt and Q493X-mut on the chip.

A match/mismatch distinction is observed for all the mutations.

Materials and Methods: Hybridization Conditions

3′-end-labeled oligonucleotides from the company Metabion were used. The quality of the oligonucleotides was verified in a 20% polyacrylamide gel under denaturing conditions.

The hybridization of the fluorophore-labeled oligonucleotides on the chip was carried out in a solution of type 2×SSC, 0.2% SDS, 0.2 mg/ml BSA, at ambient temperature for 12 hours. The volume of the hybridization chamber was 180 μl, and the concentration of each oligonucleotide was 0.1 μM.

The post-hybridization washing of the chip was then carried out in a solution of 2×SSC, 0.2% SDS, for one minute at ambient temperature.

The chip was then dried by centrifugation for one minute at 500×g, in accordance with the TeleChem protocol, and was then read.

In general, this application of the invention comprises the use of a CFTR chip according to the invention, for detecting the possible presence of a mutation in the sequence of the CFTR gene of a patient, preferably using the reader according to the invention.

The essential steps of this method are as follows:
Preparation of the target polynucleotide or oligonucleotide:
   The genomic DNA, or the messenger RNAs, or fragments thereof, are extracted from the biological sample according to the methods commonly used by those skilled in the art. Using recombinant DNA technologies, the RNAs are optionally converted to cDNAs (complementary DNAs). The DNA thus isolated is then fragmented and/or subjected to amplification by PCR so as to generate oligonucleotide fragments. The latter are labeled, before, during or after, with signal-generating labels according to conventional methods. According to a preferred embodiment, the DNA thus isolated is amplified by PCR with a primer specific for the region of the CFTR gene tested, using labeled or modified nucleotides. The DNAs, cDNAs or RNAs thus labeled are then denatured so as to obtain single-stranded molecules.
Fluorescent labeling of the ssPCR product
   An exon 10 ssPCR product (length of approximately 400 nt) was 3′-end labeled with Cy3 or Cy5 fluorescent labels as follows:

100 pmol of ssPCR product were dissolved in 25 μl of a solution (1×TdT buffer, 400 pmol of Cy3-UTP (or Cy5-UTP) in water),

10 units of TdT were added.

The reaction was carried out at 37° C. for 1 hour. The nonbound labels were eliminated with Qiagen® DyeEx™ Spin Kit columns according to the Qiagen protocol.

Hybridization of the target DNAs with the oligonucleotides of the chip:
   The DNAs, cDNAs or RNAs thus labeled and denatured are then spotted onto the chip and, where appropriate, bind by specific hybridization, under defined stringency hybridization conditions, with the oligonucleotide probes. After washing to remove the excess labeled DNAs, cDNAs or RNAs and/or those hybridized non-specifically, the duplexes formed are detected using the reader according to the invention.

The analysis of the mutations in the CFTR gene can be carried out according to a first method which consists in comparing the intensities of the hybridization signals of the wild-type (wt) and/or mutated target oligonucleotides on the CFTR biochip, using a single type of target oligonucleotide labeled with a fluorophore. A second approach uses the hybridization, on the CFTR chip, of at least two different target oligonucleotides labeled with different signal-generating labels, one of the oligonucleotides coming from the sample to be tested, the other corresponding to a reference oligonucleotide (in general, the oligonucleotide corresponding to the wild-type sequence).

Hybridization

The hybridization of probes on said target oligonucleotides is carried out at a temperature of approximately 20° C. in the hybridization buffer defined hereinafter and containing no formamide. Those skilled in the art will have to adjust these hybridization conditions if the hybridization medium used contains formamide.

Preferably, the hybridization medium for said CFTR chip according to the invention comprises at least 6×SSC (1×SSC corresponds to a solution of 0.15M NaCl+0.015M sodium citrate), 0.2% sodium dodecyl sulfate and, optionally, 0.2 mg/ml of bovine serum albumin. Those skilled in the art may optionally modify these conditions with compounds having a similar function in the hybridization buffer. Thus, replacing the bovine serum albumin with gelatin, or the SSC buffer with SSPE buffer (5×SSPE is made up of 750M NaCl, 50 mM Na phosphate, 5 mM EDTA, pH 7.4), could be envisioned.

The expression “conditions allowing the specific hybridization of target nucleic acids with said oligonucleotide probes” preferably refers to high stringency conditions, in particular as defined hereinafter. “Stringent” conditions are conditions under which a probe will hybridize on its target sequence, but not on the other sequences. The stringency conditions depend on the sequence, and are different according to circumstances. A variety of factors can influence the hybridization stringency. Among these, mention should be made of the base composition, the size of the complementary strands, the presence of organic solvents and the length of the base mismatches. For a discussion on the general factors that influence hybridization, reference may, for example, be made to WO 93/02216 or Ausubel et al. (Current Protocol in Molecular Biology, Greene Publishing Associates, Inc. and John Wiley and Sons, Inc.). In general, the stringency conditions are selected such that the temperature is 5° C. lower than the melting point (Tm), for a specific sequence at a defined ionic strength and pH. The Tm is the temperature (under defined conditions of ionic strength, of pH and of nucleic acid concentration) at which 50% of the probes complementary to a target sequence hybridize to the target sequence at equilibrium. Conventionally, stringency conditions include a salt concentration from at least approximately 0.01M up to 1M in terms of concentration of sodium or of other salts, at a pH of from 7.0 up to 8.3, and a temperature of at least approximately 30° C. for small probes (10 to 50 nucleotides). Stringency conditions can also be obtained with the addition of destabilizing agents such as formamide or tetraalkylammonium salts. for example, the stringency conditions of 5×SSPE (750M NaCl, 50 mM Na phosphate, 5 mM EDTA, pH 7.4) and a temperature of 25° C.-30° C. are conditions normally used for the hybridization of allele-specific probes.

A hybridization under high stringency conditions means that the conditions of temperature and of ionic strength are chosen such that they allow the hybridization between two complementary DNA/DNA or RNA/DNA fragments to be maintained. By way of illustration, high stringency conditions for the hybridization step for the purposes of defining the hybridization conditions described above are advantageously as follows: the DNA-DNA or DNA-RNA hybridization is carried out in two steps: (1) pre-hybridization at 42° C. for 3 hours in phosphate buffer (20 mM, pH 7.5) containing 5×SSC, 50% formamide, 7% sodium dodecyl sulfate (SDS), 10× Denhardt's, 5% dextran sulfate and 1% salmon sperm DNA; (2) hybridization per se for 20 hours at a temperature that depends on the size of the probe (i.e.: 42° C. for a probe >100 nucleotides in size) followed by 2 washes of 20 minutes at 20° C. in 2×SSC+2% SDS, and 1 wash of 20 minutes at 20° C. in 0.1×SSC+0.1% SDS. The final wash is carried out in 0.1×SSC+0.1% SDS for 30 minutes at 60° C., for a probe >100 nucleotides in size. The high stringency hybridization conditions described above for a polynucleotide of defined size can be adjusted by those skilled in the art for longer or shorter oligonucleotides, according to the teaching of Sambrook et al. (1989, Molecular cloning: a laboratory manual. 2nd Ed. Cold Spring Harbor).

Finally, the hybridization can be carried out in a more or less humid atmosphere. Low-humidity or high-humidity hybridization conditions may make it possible to optimize the hybridization specificity.

The stringency can be determined empirically by gradually increasing the stringency conditions, for example by increasing the salt concentration, or by increasing the temperature until the desired specificity level is obtained. The present invention thus makes it possible to increase the stringency conditions by precisely controlling an increase in temperature.

The invention also provides a kit for diagnosing cystic fibrosis, comprising an array of oligonucleotides or CFTR chip according to the invention. The kit or pack for detecting mutations in or for genotyping the human CFTR gene in a sample is characterized in that it comprises a CFTR chip according to the invention and, optionally, the reagents required for labeling the target oligonucleotides or polynucleotides. An object of the present invention is therefore also to use the array of oligonucleotides according to the invention, or CFTR chip, for diagnosing cystic fibrosis in an individual.

A subject of the present invention is also a method for detecting mutations in the CFTR gene from a sample, characterized in that it comprises the following steps:

a) spotting the sample containing target oligonucleotides or polynucleotides, derived from the human CFTR gene in which it is sought to detect the possible presence of mutations, onto a chip coated with oligonucleotide probes according to the invention, under conditions which allow the specific hybridization of these target oligonucleotides or of the target polynucleotides with said oligonucleotide probes;

b) where appropriate, rinsing the chip obtained in step a) under the appropriate conditions in order to remove the nucleic acids of the sample that have not been captured by hybridization; and

c) detecting, optionally using the reader according to the invention, the nucleic acids captured on the chip by hybridization.

One of the objects of the present invention is also to provide an in vitro method for diagnosing cystic fibrosis in an individual, comprising the following steps:
(a) obtaining at least one DNA fragment derived from the CFTR gene of an individual;
(b) labeling said fragment with a signal-generating label; optionally, denaturing said fragment so as to obtain a single-stranded fragment;
(c) hybridizing said labeled fragment with an array of oligonucleotides according to the invention;
(d) detecting the DNA fragment that hybridizes specifically with one or more oligonucleotides of said array;
(e) optionally, determining the presence of a mutation in the CFTR gene in said individual.

According to a preferred embodiment of the invention, said fragments are labeled, in step (b), directly or indirectly with a signal-generating label according to the invention; preferably, it is a fluorescent label chosen from the group composed of Cy3, Cy5, FITC, Texas Red (Rhodamine), Bodipy 630/650, Alexa 488, Alexa 350, etc.

According to a first embodiment, a single target nucleic acid labeled with a signal-generating label is hybridized on said CFTR chip.

According to a second embodiment, at least one, at least 2, at least 3, at least 4, at least 5, at least 6, at least 7, at least 8, at least 9 or at least 10 target nucleic acids labeled with a signal-generating label is (are) hybridized on said CFTR chip.

The reader according to the invention in fact makes it possible to detect hybrids or duplexes labeled with different markers, simultaneously or separately over time.

1. A device for reading and analyzing chips, comprising:
a table for receiving a chip intended to characterize at least one sample,
means of exciting the molecules or the cells of the chip, after reaction with other molecules,
means of reading and analyzing the molecules subjected to excitation,
characterized in that the device also comprises:
a unit for controlling the temperature of said table, said control unit being connected to a module (111) consisting of a plurality of Peltier-type heating/cooling elements arranged opposite various spots on the surface of the table,
and at least one table temperature sensor (112) also connected to said control unit.

2. The device as claimed in the preceding claim, characterized in that the excitation means comprise a broad-spectrum lamp and at least one laser.

3. The device as claimed in either of the preceding claims, characterized in that the laser is a laser whose radiation is centered on a wavelength of the order of 635 nm.

4. The device as claimed in one of the preceding claims, characterized in that the reader comprises several lasers.

5. The device as claimed in the preceding claim, characterized in that the lasers are centered on the same wavelength.

6. The device as claimed in one of the preceding claims, characterized in that the excitation means comprise at least one laser associated with a module for scanning of its beam so as to excite the molecules to be analyzed.

7. The device as claimed in the preceding claim, characterized in that the reader comprises two lasers and the modules for scanning of the two lasers control two respective scans of the molecules in two orthogonal directions.

8. The device as claimed in one of claims 1 to 5, characterized in that the excitation means comprise at least one laser assembly comprising a laser whose radiation is guided by an optical fiber.

9. The device as claimed in the preceding claim, characterized in that the excitation means comprise two identical laser assemblies.

10. The device as claimed in one of claims 1 to 5, characterized in that the excitation means comprise a fixed laser (132″) which directs its beam toward two successive mirror assemblies mounted in series, and the movement of which is controlled along two different directions.

11. The device as claimed in the preceding claim, characterized in that the movement of the two mirror assemblies is controlled so as to produce a beam which can follow any desired sequence on the chip.

12. The device as claimed in one of claims 1 to 5, characterized in that the excitation means comprise a lamp and a laser whose radiations follow the same optical path due to a swinging mirror (130) that can pivot around an axis (1300) between two positions so as to direct one of these two radiations toward the chip.

13. The device as claimed in one of the preceding claims, characterized in that an optical system is interposed between the lamp and the molecules to be excited, whereas the laser excitation takes place by direct illumination of the molecules.

14. The device as claimed in the preceding claim, characterized in that said optical system comprises narrow bandwidth excitation light filters and narrow bandwidth emission light filters, and a beam separator.

15. The device as claimed in one of the preceding claims, characterized in that the reader also comprises an excitation control unit connected to each of the excitation means in order to control the functioning thereof.

16. The device as claimed in the preceding claim, characterized in that said excitation control unit is capable of selectively controlling the simultaneous or successive illumination of the molecules with the lamp and at least one laser, or the separate excitation of the molecules with the lamp and at least one laser.

17. A device for reading and analyzing chips, comprising:
a table for receiving a chip intended to characterize at least one sample,
means of exciting the cells or molecules of the chip, after reaction with other molecules or cells,
means of reading the molecules or cells subjected to excitation,
characterized in that the reader also comprises a temperature control unit.

18. The device as claimed in the preceding claim, characterized in that the table comprises a temperature sensor connected to said temperature control unit.

19. The device as claimed in either of the two preceding claims, characterized in that the reader comprises a heating/cooling module associated with the table and intended to control its temperature, said heating/cooling module being connected to the temperature control unit.

20. The device as claimed in one of the three preceding claims, characterized in that the reader also comprises processing means comprising a microprocessor and connected to the temperature control unit and also to the reading means.

21. The device as claimed in the preceding claim, characterized in that the reader comprises means of storing reference curves of the response of the matches and mismatches of the molecules to the excitation means as a function of the temperature.

22. The device as claimed in the preceding claim, characterized in that the storage means are connected to means for determining a melting temperature for the matches and mismatches of the molecules, from said reference curves.

23. The device as claimed in one of the six preceding claims, characterized in that the temperature control unit is capable of controlling the functioning of the reader according to a “static” mode in which pre-established reference curves of the response of the matches and mismatches of the molecules as a function of the temperature are used to establish a set temperature that can be transmitted, by said temperature control unit, so as to control the temperature of said table.

24. The device as claimed in one of the seven preceding claims, characterized in that the temperature control unit is capable of controlling the functioning of the reader according to a “dynamic” mode in which the temperature control unit controls a given change in temperature on the table, and, during this change in temperature:
the reading means collect, in real time, the response of the molecules associated with the various spots on the chip to the excitation by the excitation means, and transmit said response to processing means (18),
storage means store, for each spot on the chip, the change in response of the molecule as a function of the temperature.

25. The device as claimed in the preceding claim, characterized in that the reader comprises processing means capable of establishing, for each molecule, at the end of the storage of said change in response, a diagnosis of state of the molecule.

26. The device as claimed in the preceding claim, characterized in that said diagnosis of state is a match/mismatch diagnosis.

27. A method of hybridization of the oligonucleotides of a chip, which can be carried out by means of a reader as claimed in one of the preceding claims, the method comprising the steps consisting in:
bringing the nucleic acid probes corresponding to a target nucleic acid into contact with a biological sample containing single-stranded DNA fragments, so as to carry out a selective hybridization of certain probes with said single-stranded DNA fragments of the sample, by forming duplexes,
reading the duplexes thus formed,
characterized in that the method comprises a step consisting of automatic determination of:
the melting temperature for each target nucleic acid in a “match” configuration, and
the melting temperature for each target nucleic acid in a “mismatch” configuration.

28. The method as claimed in the preceding claim, characterized in that said determination is carried out in the “static” mode using reference curves illustrating the change, as a function of the temperature, in the signal received by means of reading duplexes corresponding, respectively, to matches and to mismatches.

29. The method as claimed in the preceding claim, characterized in that the method comprises controlling the temperature so as to carry out the hybridization at a temperature corresponding to a maximum distinction between match and mismatch.

30. The method as claimed in the preceding claim, characterized in that the method comprises producing said reference curves during a step that precedes the reading step.

31. The method as claimed in the preceding claim, characterized in that the method comprises storing said reference curves.

32. The method as claimed in one of the five preceding claims, characterized in that said determination can be carried out in the “dynamic” mode by controlling a given change in temperature of the samples, and, during this change in temperature, the following are carried out:
real-time collection of the response of the duplexes associated with the various spots on the chip to the excitation by the excitation means,
for each duplex, storage of the change in the response as a function of the temperature.

33. The method as claimed in the preceding claim, characterized in that the method comprises, for each duplex, establishing, at the end of the storage of said change in response, a diagnosis of match/mismatch of the duplex.


SEQUENCE LISTING (33 sequences)

SEQ ID NO: 1 - DNA, 24 bp, Artificial Sequence
  Description of Artificial Sequence Synthetic probe
taggaaacaccaaagatgatattt

SEQ ID NO: 2 - DNA, 24 bp, Artificial Sequence
  Description of Artificial Sequence Synthetic probe
cataggaaacaccaatgatatttt

SEQ ID NO: 3 - DNA, 21 bp, Artificial Sequence
  Description of Artificial Sequence Synthetic probe
aggaaaactgagaacagaatg

SEQ ID NO: 4 - DNA, 21 bp, Artificial Sequence
  Description of Artificial Sequence Synthetic probe
aggaaaactaagaacagaatg

SEQ ID NO: 5 - DNA, 21 bp, Artificial Sequence
  Description of Artificial Sequence Synthetic probe
aggaaaacttagaacagaatg

SEQ ID NO: 6 - DNA, 22 bp, Artificial Sequence
  Description of Artificial Sequence Synthetic probe
accttctccaagaactatattg

SEQ ID NO: 7 - DNA, 22 bp, Artificial Sequence
  Description of Artificial Sequence Synthetic probe
accttctcaaagaactatattg

SEQ ID NO: 8 - DNA, 22 bp, Artificial Sequence
  Description of Artificial Sequence Synthetic probe
accttctctaagaactatattg

SEQ ID NO: 9 - DNA, 17 bp, Artificial Sequence
  Description of Artificial Sequence Synthetic probe
ttcttgctcgttgacct

SEQ ID NO: 10 - DNA, 17 bp, Artificial Sequence
  Description of Artificial Sequence Synthetic probe
ttcttgctcattgacct

SEQ ID NO: 11 - DNA, 17 bp, Artificial Sequence
  Description of Artificial Sequence Synthetic probe
ttcttgctccttgacct

SEQ ID NO: 12 - DNA, 17 bp, Artificial Sequence
  Description of Artificial Sequence Synthetic probe
tcgttgacctccactca

SEQ ID NO: 13 - DNA, 17 bp, Artificial Sequence
  Description of Artificial Sequence Synthetic probe
tcgttgatctccactca

SEQ ID NO: 14 - DNA, 17 bp, Artificial Sequence
  Description of Artificial Sequence Synthetic probe
tcgttgaactccactca

SEQ ID NO: 15 - DNA, 15 bp, Artificial Sequence
  Description of Artificial Sequence Synthetic probe
accttctccaagaac

SEQ ID NO: 16 - DNA, 15 bp, Artificial Sequence
  Description of Artificial Sequence Synthetic probe
accttctcaaagaac

SEQ ID NO: 17 - DNA, 15 bp, Artificial Sequence
  Description of Artificial Sequence Synthetic probe
accttctctaagaac

SEQ ID NO: 18 - DNA, 15 bp, Artificial Sequence
  Description of Artificial Sequence Synthetic probe
cttgctcgttgacct

SEQ ID NO: 19 - DNA, 15 bp, Artificial Sequence
  Description of Artificial Sequence Synthetic probe
cttgctcattgacct

SEQ ID NO: 20 - DNA, 15 bp, Artificial Sequence
  Description of Artificial Sequence Synthetic probe
cttgctccttgacct

SEQ ID NO: 21 - DNA, 15 bp, Artificial Sequence
  Description of Artificial Sequence Synthetic probe
tcgttgacctccact

SEQ ID NO: 22 - DNA, 15 bp, Artificial Sequence
  Description of Artificial Sequence Synthetic probe
tcgttgatctccact

SEQ ID NO: 23 - DNA, 15 bp, Artificial Sequence
  Description of Artificial Sequence Synthetic probe
tcgttgaactccact

SEQ ID NO: 24 - DNA, 24 bp, Artificial Sequence
  Description of Artificial Sequence Synthetic oligonucleotide
aaatatcatctttggtgtttccta

SEQ ID NO: 25 - DNA, 24 bp, Artificial Sequence
  Description of Artificial Sequence Synthetic oligonucleotide
aaaatatcattggtgtttcctatg

SEQ ID NO: 26 - DNA, 21 bp, Artificial Sequence
  Description of Artificial Sequence Synthetic oligonucleotide
cattctgttctcagttttcct

SEQ ID NO: 27 - DNA, 21 bp, Artificial Sequence
  Description of Artificial Sequence Synthetic oligonucleotide
cattctgttcttagttttcct

SEQ ID NO: 28 - DNA, 18 bp, Artificial Sequence
  Description of Artificial Sequence Synthetic oligonucleotide
aatatacttggagaaggt

SEQ ID NO: 29 - DNA, 18 bp, Artificial Sequence
  Description of Artificial Sequence Synthetic oligonucleotide
accttctcaaagtatatt

SEQ ID NO: 30 - DNA, 17 bp, Artificial Sequence
  Description of Artificial Sequence Synthetic oligonucleotide
aggtcaacgagcaagaa

SEQ ID NO: 31 - DNA, 17 bp, Artificial Sequence
  Description of Artificial Sequence Synthetic oligonucleotide
aggtcaatgagcaagaa

SEQ ID NO: 32 - DNA, 17 bp, Artificial Sequence
  Description of Artificial Sequence Synthetic oligonucleotide
tgagtggaggtcaacga

SEQ ID NO: 33 - DNA, 17 bp, Artificial Sequence
  Description of Artificial Sequence Synthetic oligonucleotide
tgagtggagatcaacga